(19) United States
(12) Patent Application Publication
(10) Pub. No.: US 2025/0371852 A1
(43) Pub. Date: Dec. 4, 2025

(54) METHOD FOR IDENTIFYING AND DETECTING EDGES AND CORNERS OF SEED CRYSTAL SINGLE CRYSTAL WIRE IN CRYSTAL GROWTH PROCESS

(71) Applicant: BAODING JINGXIN ELECTRIC CO., LTD., Baoding, Hebei (CN)

(72) Inventors: Qinghong ZHENG, Baoding, Hebei (CN); Jie ZHAO, Baoding, Hebei (CN); Zhenlei YANG, Baoding, Hebei (CN); Zhiqi FANG, Baoding, Hebei (CN)

(73) Assignee: BAODING JINGXIN ELECTRIC CO., LTD., Baoding, Hebei (CN)

(21) Appl. No.: 18/845,448

(22) PCT Filed: Dec. 21, 2023
(86) PCT No.: PCT/CN2023/140533

§ 371 Date: Aug. 18, 2025

(30) Foreign Application Priority Data
Dec. 29, 2022 (CN) 202211717017.X

(51) Int. Cl. G06V 10/776; G06T 7/00; G06T 7/13; G06V 10/44; G06V 10/774

(52) U.S. Cl. CPC G06V 10/776; G06T 7/0004; G06T 7/13; G06V 10/44; G06V 10/774; G06T 2207/20081; G06T 2207/30108

(57) ABSTRACT

The present application relates to the technical field of identification during crystal growth, and specifically relates to a method for identifying and detecting the edges and corners of a seed crystal single crystal wire in a crystal growth process, comprising four steps, i.e., constructing a high-quality data set, constructing an artificial intelligence algorithm model, performing model training, and performing model evaluation and verification. The present invention overcomes the defects of manual determination of the starting time of a seeding procedure, and provides a method for automatically determining the seeding time, so that a control system automatically controls the operation of starting the seeding procedure after temperature adjustment is ended.

### CROSS-REFERENCE

This application claims priority to Chinese Patent Application No. 202211717017.X, titled “METHOD FOR IDENTIFYING AND DETECTING EDGES AND CORNERS OF SEED CRYSTAL SINGLE CRYSTAL WIRE IN CRYSTAL GROWTH PROCESS”, filed on Dec. 29, 2022 with the China National Intellectual Property Administration, which is incorporated herein by reference in its entirety.

### FIELD

The present disclosure relates to the field of crystal growth identification, and in particular to a method for identifying and detecting an edge and a corner of a monocrystal line of a seed crystal in a crystal growth process.

### BACKGROUND

In conventional monocrystal growth control systems, a seeding process is started after a temperature regulation (temperature stabilization) process is completed. Generally, it is manually determined whether the seeding process can be started based on an angular state of a monocrystal line of a seed crystal. It is determined that the seeding process can be started in a case that the monocrystal line of the seed crystal is in a full angular state. However, in the above manner, factors, such as different skill levels of the staff and different determination rules, may results in different timing of starting the seeding process, affecting the yield and the finished product rate. Presently, no automated solutions are provided in the industry for determining a time instant when the seeding process is to be started.

Moreover, for the above operations performed manually, it requires a large number of staff to constantly monitor and operate, affecting production costs, output, and efficiency.

### SUMMARY

To solve the above problems, a method for identifying and detecting an edge and a corner of a monocrystal line of a seed crystal in a crystal growth process according to the present disclosure.

To solve the above technical problems, the following technical solutions are provided according to the present disclosure. A method for identifying and detecting an edge and a corner of a monocrystal line of a seed crystal in a crystal growth process, includes:
step S1, collecting, by using an industrial camera in a CCD system, an angular image of the monocrystal line of the seed crystal that meets a seeding condition after a temperature regulation process and before a seeding process, performing single-frame labeling processing on feature points based on the collected angular image to construct a data set; and dividing the data set into a training set, a testing set, and a verification set based on a first proportion; where the data set is divided based on the proportion, so that the data of the training set and the data of the verification set can be ensured, and the model can learns sufficient features, and it is ensured that the accuracy of the model can be tested based on the data of the testing set;
step S2, determining a pre-training model based on a labeled data set and a system application scenario, and constructing a training algorithm for a deep learning model based on the pre-training model, where the training algorithm includes image data processing, loss value calculation, and weight parameter iteration of the pre-training model; where the pre-training model is a mathematical model with initialized parameters, and compared to constructing a model, the model learning speed can be improved with the pre-training model;
step S3, performing an iteration training process using the training algorithm for the deep learning model based on data in a labeled training set; performing real-time verification with the verification set in the iteration training process, and recording a loss value of the training set and a loss value of the verification set; determining a learning state of the pre-training model based on a change of the loss value of the verification set, and saving a current optimal model in real time; and obtaining an overall optimal model after m epoch training processes, where m represents a positive integer; and
step S4, testing the overall optimal model based on the testing set to obtain a model identification accuracy, and determining whether the model identification accuracy meets an actual production standard.

In an embodiment, the seeding condition in step S1 indicates that the monocrystal line is in a full angular state, the feature points indicate an edge and a corner of the seed crystal meeting the seeding condition in the angular image, and the single-frame labeling processing is performed for labeling the feature points of the edge and the corner.

In an embodiment, the performing an iteration training process based on data in a labeled training set, performing real-time verification with the verification set in the iteration training process, and recording a loss value of the training set and a loss value of the verification set in step S3 includes:
step S31, inputting an image with a size of 640*640*3, slicing the inputted image using a Focus module to obtain a sliced image with a size of of 320*320*12, integrating a height and a width of the sliced image using Concat, and adding the number of channels of the inputted image to obtain a first processed image with a size of 320*320*64, where the number of the channels of the inputted image is 64;
step S32, performing feature extraction on the integrated image by using a convolution module Conv with a size of 3 and a step size of 2, and outputting a first feature image with a size of 160*160*128;
step S33, performing convolution on the first feature image using three sets of BottleneckCSP1 and Conv to obtaining a second feature image with a size of 20*20*1024; performing four maximum pooling operations, including a 1*1 maximum pooling operation, a 5*5 maximum pooling operation, a 9*9 maximum pooling operation and a 13*13 maximum pooling operation, on the second feature image by using a SSP module to extract image features, and aggregating, by using Concat, four feature images after the four maximum pooling operations to obtain a third feature image; where the SSP module is used for improving the accuracy of the model;
step S34, processing the third feature image by using a BottleneckCSP2 module to reduce the number of parameters of the pre-training model, and performing an up-sampling operation to obtain a fourth feature image with a size of 80*80*512;
step S35, performing a down-sampling operation on the fourth feature image to obtain a 80*80*512 feature image, a 40*40*512 feature image, and a 20*20*512 feature image;
step S36, performing a Conv2d convolution operation respectively on the 80*80*512 feature image, the 40*40*512 feature image and the 20*20*512 feature image to obtain a 80*80*255 feature image, a 40*40*255 feature image, and a 20*20*255 feature image;
step S37, outputting a prediction frame based on the 80*80*255 feature image, the 40*40*255 feature image, the 20*20*255 feature image, and the parameters of the pre-training model; comparing the prediction frame with a real frame labeled in the feature images to calculate a loss value of the prediction frame and a loss value of the real frame; and performing reverse updating and iteration to optimize weight parameters of the pre-training model; and
step S38, performing iteration on the parameters of the pre-training model based on the data of the training set, and outputting a weight parameter model obtained by the real-time epoch iteration training process.

In an embodiment, the iteration process for the weight parameters in step S37 includes:
assuming a hyper-parameter β1 meeting 0≤β1≤1, where β1 is set to 0.9, and obtaining a weighted average of a momentum variable vₜ and a random gradient gₜ at a time step t:

$$vt ← β 1 {v}_{t - 1} + ( 1 - β 1 ) {g}_{t}$$

at the time step t, obtaining:

$$vt = ( 1 - β 1 ) {\sum }_{i = 1}^{t} β {1}^{t - i} {g}_{i}$$

where gᵢ represents a random gradient at a time step i, and weights of random gradients of past time steps are added:

$$( 1 - β 1 ) {\sum }_{i = 1}^{t} β {1}^{t - i} {g}_{i} = 1 - β {1}^{t}$$

performing deviation correction, where in a case that t is small, a sum of batch random gradients of the past time steps is small, and for any time step t, dividing vₜ by 1−β1^{t} to obtain:

$${v}_{t}^{′} ← \frac{{v}_{t}}{1 - β {1}^{t}}$$

obtaining a weighted average of a variable nₜ and a square of the random gradient gₜ at the time step t:

$${n}_{t} ← β 1 {n}_{t - 1} + ( 1 - β 1 ) {g}_{t}^{2}$$

reducing impact of small t by

$${n}_{t} ← β 1 {n}_{t - 1} + ( 1 - β 1 ) {g}_{t}^{2}$$

obtaining corrected

$${v}_{t}^{′} \cdot {n}_{t}^{′}$$

at each time step t, and adjusting a learning rate of each of weight parameters in the parameters of the training model by performing an element-by-element operation:

$${g}_{t}^{′} ← \frac{η {v}_{t}^{′}}{\sqrt{{n}_{t}^{′}} + ϵ}$$

where η represents the learning rate, and ϵ represents a constant and ϵ=10⁻⁸; and
using the calculated gₜ′ to iterate the weight parameters in the model, and obtaining:

$$w\_t ← w\_ ( t - 1 ) - {g\_t}^{′}$$

In an embodiment, the step S3 further includes:
in each real-time epoch iteration training process, continuously performing the iteration process of the weight parameters, continuously updating the weight parameters of the pre-training model, and obtaining the weight parameter model obtained by the current epoch iteration training process after repeated iteration learning, that is, updating of the weight parameters; and
after each epoch iteration training process, predicting a result of the verification set using the weight parameter model obtained by the current epoch iteration training process, where the predicting the result is same as the steps S31-S37, and calculating the loss value of the verification set.

In an embodiment, the calculating the loss value of the verification set includes:
establishing a loss function of the pre-training model, where a rectangular frame loss value lossrect, a confidence loss value lossobj, and a classification loss value lossclc are involved in training and verifying the model:

$$Loss = a * lossobj + b * lossrect + c * lossclc$$

where a, b, and c represent weights, and a=0.4, b=0.3, c =0.3;
using the loss function as the loss value of the training set and the loss value of the verification set;
where the rectangular frame loss value lossrect is calculated by using the pre-training model based on CLOU_loss as follows:

$$CIOU\_loss = 1 - CIOU$$

$$CIOU - IOU - \frac{Distance\_ {2}^{2}}{{Distance\_C}^{2}} - \frac{{V}^{2}}{( 1 - IOU ) + V}$$

where IOU=A/B, A represents the number of pixels of an intersection of a labeled real frame and the prediction frame, B represents the number of pixels of a union of the labeled real frame and the real frame, Distance_C represents a diagonal distance of a minimum bounding rectangle of the labeled real frame and the prediction frame, Distance_2 represents an Euclidean distance between a central point of the labeled real frame and a central point of the prediction frame, and V represents a parameter for measuring consistency of an aspect ratio and is defined as:

$$V = \frac{4}{π} {( arctan \frac{{w}^{gt}}{{h}^{gt}} - arctan \frac{{w}^{p}}{{h}^{p}} )}^{2}$$

where wgt represents a width of the real frame, hgt represents a length of the real frame, wp represents a width of the prediction frame, and hp represents a length of the prediction frame.

In an embodiment, the loss value of the verification set is further calculated by:
calculating the confidence loss value lossobj and the classification loss value lossclc by using the pre-training model based on BCE_loss:

$$BCE\_loss = - \frac{1}{f} {\sum }_{u} ( {y}_{f} * Ind + ( 1 - {y}_{f} ) * ( ln ( 1 - Ind ) ) )$$

where f represents the total number of samples, u represents the samples, y_{f} represents a label, and d represents a predicted output;
in the case of calculating the confidence loss value, f represents the number of data samples involved in training or verifying the model, u represents a sample among the samples, y_{f} represents a sample labeling confidence, and d represents a prediction confidence;
in the case of calculating the classification loss value, f represents the number of data samples involved in training or verifying the model, u represents a sample among the samples, y_{f} represents a sample labeling category, and d represents a prediction category;
obtaining, based on the above calculation, a loss value of the weight parameter model based on the verification set after the real-time epoch training process;
where after each epoch iteration training process, a weight parameter model is obtained, and a loss value of the weight parameter model based on the verification set is obtained.

In an embodiment, the determining a learning state of the pre-training model based on a change of the loss value of the verification set, and saving a current optimal model in real time; and obtaining an overall optimal model after m epoch training processes where m represents a positive integer includes:
outputting a loss value of the verification set after a single epoch as a single loss value of the verification set;
determining that the model is learning the image features in a case that the single loss value of the verification set decreases in the training process;
determining that an output model reaches a maximum learning limit in a case that the single loss value of the verification set remains unchanged, that is, a difference between single loss values of the verification set corresponding to adjacent epochs is less than or equal to a difference threshold;
outputting the weight parameter model reaching the maximum learning limit as a real-time optimal model; and
outputting a weight parameter model with a minimum loss value of the verification set in the training process as the overall optimal model, where the loss value of the verification set is a set of values including single loss values of the verification set corresponding to the weight parameter model reaching the maximum learning limit in the m epoch training processes, and the overall optimal model is an optimal model in 350 epoch training processes.

In an embodiment, the step S4 includes:
testing the overall optimal model based on on the testing set, and calculating the IOU of the prediction frame and a labeled frame of the data set;
calculating an average detection precision mAP for all categories based on the following equation:

$$mAP = \frac{sum ( AP )}{n}$$

where AP represents an average precision of all images for each of the categories, and n represents the number of the categories for detection;
where the AP equal to an area value of a region enclosed by a precision ratio Precision, a recall ratio Recall, an X axis, and a Y axis;

$$Precision = \frac{TP}{TP + FP}$$

$$Recall = \frac{TP}{GT}$$

where TP represents the number of detection frames in a case of IOU greater than a predetermined IOU threshold, FP represents the number of the detection frames in a case of IOU less than or equal to the predetermined IOU threshold, and GT represents the number of the labeled frames of the data set;
calculating an AP value for each of the categories for detection, that is, mAP=AP; and
configuring an accuracy threshold r corresponding to the actual production standard, where in a case that mAP is greater than or equal to r, the outputted overall optimal model meets the actual production standard.

Compared to the conventional technology, the following technical effects can be achieved with the present disclosure. According to the present disclosure, the artificial intelligence technology in image identification is used, training is performed by using a deep learning algorithm based on a large number of picture data of related scenarios to obtain an optimal model, so that an angular state of a monocrystal line of a seed crystal can be accurately detected, and the crystal growth control system using the optimal model can automatically determine the time instant when the seeding process is to be started, avoiding draw backs of manual operation. To overcome the shortcomings of manual determination for the time instant when the seeding process is to be started, a method for automatically determining a time instant when a seeding process is to be started is provided, so that the control system can automatically control the seeding process to be started after the temperature regulation process. Thus, an automatic transition from the temperature regulation process to the seeding process is performed without manual intervention, thereby achieving a standard seeding process, improving product qualification rate, improving the production efficiency, and reducing the production costs.

### BRIEF DESCRIPTION OF THE DRAWINGS

In order to more clearly describe the technical solutions in the embodiments of the present disclosure or the technical solutions in the conventional technology, drawings to be used in the description of the embodiments or the conventional technology are briefly described hereinafter. It is apparent that the drawings described below are merely used for describing the embodiments of the present disclosure, and those skilled in the art can obtain other drawings according to the provided drawings without any creative effort.

FIG. 1 is a flowchart of a method for identifying and detecting an edge and a corner of a monocrystal line of a seed crystal in a crystal growth process according to an embodiment of the present disclosure;

FIG. 2 is a schematic diagram of a convolution operation in a method for identifying and detecting an edge and a corner of a monocrystal line of a seed crystal in a crystal growth process according to an embodiment of the present disclosure;

FIG. 3 is a schematic diagram of a maximum pooling operation in a method for identifying and detecting an edge and a corner of a monocrystal line of a seed crystal in a crystal growth process according to an embodiment of the present disclosure;

FIG. 4 is a schematic diagram showing changes of a loss value of a training set and changes of a loss value of a validation set in a model training process in a method for identifying and detecting an edge and a corner of a monocrystal line of a seed crystal in a crystal growth process according to an embodiment of the present disclosure;

FIG. 5 is a curve graph showing changes of an average precision in a method for identifying and detecting an edge and a corner of a monocrystal line of a seed crystal in a crystal growth process according to an embodiment of the present disclosure;

FIG. 6 shows image data not detected by a model in a method for identifying and detecting an edge and a corner of a monocrystal line of a seed crystal in a crystal growth process according to an embodiment of the present disclosure; and

FIG. 7 shows image data not detected by a model in a method for identifying and detecting an edge and a corner of a monocrystal line of a seed crystal in a crystal growth process according to an embodiment of the present disclosure.

### DETAILED DESCRIPTION

Technical solutions in the embodiments of the present application are clearly and completely described hereinafter in conjunction with the drawings of the embodiments of the present application. Apparently, the embodiments described in the following are only some embodiments of the present application, rather than all embodiments. Any other embodiments obtained by those skilled in the art based on the embodiments in the present application without any creative work fall in the scope of protection of the present disclosure.

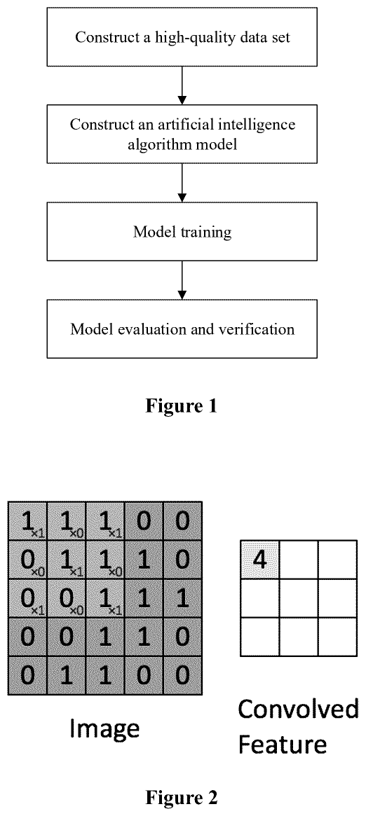

Referring to FIGS. 1 to 7, a method for identifying and detecting an edge and a corner of a monocrystal line of a seed crystal in a crystal growth process is provided according to the present disclosure. The method includes following steps S1 to S4.

In step S1, an angular image of the monocrystal line of the seed crystal that meets a seeding condition after a temperature regulation process and before a seeding process is collected by using an industrial camera in a CCD system, single-frame labeling processing is performed on feature points based on the collected angular image to construct a data set, and the data set is divided into a training set, a testing set, and a verification set based on a first proportion.

10000 images are collected, and the first proportion is 8:1:1. The constructed data set is a high-quality large-scale data set. The high-quality data set is constructed based on feature points with high accuracy and images collected in an actual production environment.

The data set is divided based on the proportion, so that the data of the training set and the data of the verification set can be ensured, and the model can learns sufficient features, and it is ensured that the accuracy of the model can be tested based on the data of the testing set.

In step S2, a pre-training model is determined based on a labeled data set and a system application scenario, and a training algorithm for a deep learning model is constructed based on the pre-training model. The training algorithm includes image data processing, loss value calculation, and weight parameter iteration of the pre-training model. The pre-training model is a mathematical model with initialized parameters, and compared to constructing a model, the model learning speed may be improved with the pre-training model.

The system application scenario includes the following hardware configuration: Intel (R) Core (™) i5-8265U CPU@1.60 GHz 1.80 GHz 8 G memory.

The system application environment is for a crystal growth process, and the process requirement is to accurately determine an edge and a corner of a seed crystal in a current state in real time.

In step S3, an iteration training process is performed using the training algorithm for the deep learning model based on data in a labeled training set, real-time verification is performed with the verification set in the iteration training process, a loss value of the training set and a loss value of the verification set are recorded, a learning state of the pre-training model is determined based on a change of the loss value of the verification set, a current optimal model is saved in real time, and an overall optimal model, after m epoch training processes, is obtained, where m represents a positive integer. 1 epoch indicates that one training process is performed based on all samples in the training set. In the present disclosure, m is set to 350.

In step S4, the overall optimal model obtained in step S3 is tested based on the testing set to obtain model identification accuracy, and it is determined whether the model identification accuracy meets an actual production standard.

The seeding condition in step SI indicates that the monocrystal line is in a full angular state, the feature points indicate an edge and a corner of the seed crystal meeting the seeding condition in the angular image, and the single-frame labeling processing is performed for labeling the feature points of the edge and the corner.

The step S3, in which the iteration training process is performed based on data in the labeled training set, the real-time verification is performed with the verification set in the iteration training process, and the loss value of the training set and the loss value of the verification set is recorded, includes the following steps S31 to S38.

In step S31, an image with a size of 640*640*3 is inputted, the inputted image is sliced using a Focus module to obtain a sliced image with a size of of 320*320*12, a height and a width of the sliced image is integrated using Concat, and the number of channels of the inputted image is added to obtain a first processed image with a size of 320*320*64, where the number of the channels of the inputted image is 64.

In step S32, feature extraction is performed on the integrated image by using a convolution module Conv with a size of 3 and a step size of 2, and a first feature image with a size of 160*160*128 is outputted.

In step S33, convolution is performed on the first feature image using three sets of BottleneckCSP1 and Conv to obtaining a second feature image with a size of 20*20*1024, four maximum pooling operations, including a 1*1 maximum pooling operation, a 5*5 maximum pooling operation, a 9*9 maximum pooling operation and a 13*13 maximum pooling operation, are performed on the second feature image by using a SSP module to extract image features, and four feature images after the four maximum pooling operations are aggregated by using Concat to obtain a third feature image. The SSP module is used for improving the accuracy of the model.

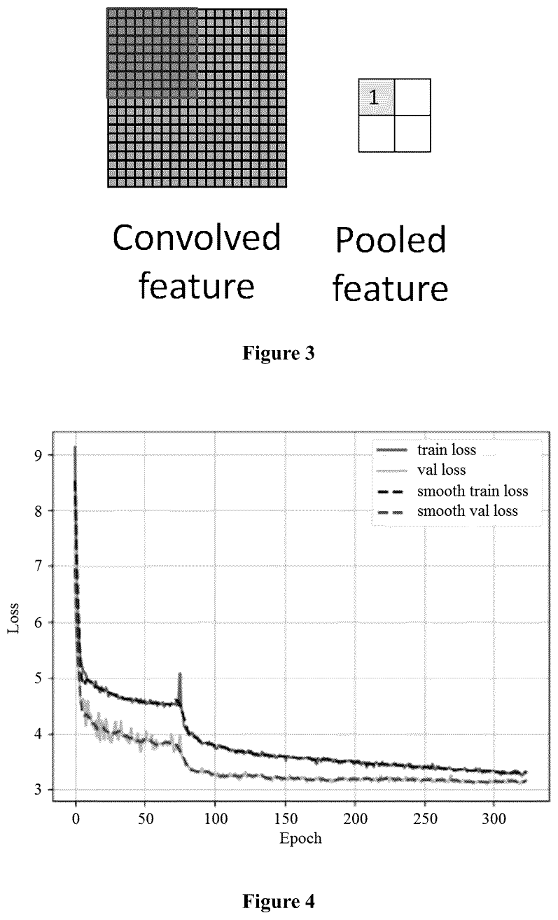

In the embodiment, the convolution operation is performed as follows. A 3*3 convolution kernel is used, and the feature image is obtained by sliding the convolution kernel on the feature images as shown in FIG. 2. The maximum pooling operation is performed as follows. 1*1, 5*5, 9*9, and 13*13 represent maximum pooling windows. Feature extraction is performed with a window on a feature image, and the extracted object is a maximum value in the window. FIG. 3 shows a 10*10 maximum pooling operation.

In step S34, the third feature image is processed by using a BottleneckCSP2 module to reduce the number of parameters of the pre-training model, and an up-sampling operation is performed to obtain a fourth feature image with a size of 80*80*512. The up-sampling operation is performed by using two sets of BottleneckCSP2, Conv with a size of 1 and a step size of 1, Upsample, and Concat.

In step S35, a down-sampling operation is performed on the fourth feature image to obtain an 80*80*512 feature image, a 40*40*512 feature image, and a 20*20*512 feature image.

In step S36, a Conv2d convolution operation is respectively performed on the 80*80*512 feature image, the 40*40*512 feature image and the 20*20*512 feature image to obtain an 80*80*255 feature image, a 40*40*255 feature image, and a 20*20*255 feature image. The processing in steps S31 to S36 corresponds to the image data processing.

In step S37, a prediction frame is outputted based on the 80*80*255 feature image, the 40*40*255 feature image, the 20*20*255 feature image, and the parameters of the pre-training model, the prediction frame is compared with a real frame labeled in the feature images to calculate a loss value of the prediction frame and a loss value of the real frame, and reverse updating and iteration is performed to optimize weight parameters of the pre-training model.

In step S38, iteration is performed on the parameters of the pre-training model based on the data of the training set, and a weight parameter model obtained by the real-time epoch iteration training process is outputted.

The iteration process for the weight parameters in step S37 includes:
assuming a hyper-parameter β1 meeting 0≤β1≤1, where β1 is set to 0.9, and obtaining a weighted average of a momentum variable vₜ and a random gradient gₜ at a time step t:

$$vt ← β 1 {v}_{t - 1} + ( 1 - β 1 ) {g}_{t}$$

at the time step t, obtaining:

$$vt = ( 1 - β 1 ) {\sum }_{i = 1}^{t} β {1}^{t - i} {g}_{i}$$

where gᵢ represents a random gradient at a time step i, and weights of random gradients of past time steps are added:

$$( 1 - β 1 ) {\sum }_{i = 1}^{t} β {1}^{t - i} {g}_{i} = 1 - β {1}^{t}$$

performing deviation correction, where in a case that t is small, a sum of batch random gradients of the past time steps is small, and for any time step t, dividing vₜ by 1−β1^{t} to obtain:

$${v}_{t}^{′} ⟵ \frac{{v}_{t}}{1 - β {1}^{t}}$$

obtaining a weighted average of a variable nₜ and a square of the random gradient gₜ at the time step t:

$${n}_{t} ⟵ β 1 {n}_{t - 1} + ( 1 - β 1 ) {g}_{t}^{2}$$

reducing impact of small t by

$${n}_{t}^{′} ⟵ \frac{{n}_{t}}{1 - β {1}^{t}} ,$$

obtaining corrected

$${v}_{t}^{′} , {n}_{t}^{′}$$

at each time step t, and adjusting a learning rate of each of weight parameters in the parameters of the training model by performing an element-by-element operation:

$${g}_{t}^{′} ⟵ \frac{η {v}_{t}^{′}}{\sqrt{{n}_{t}^{′}} + ϵ}$$

where η represents the learning rate, and ϵ represents a constant and ϵ=10⁻⁸; and
using the calculated

$${g}_{t}^{′}$$

to iterate the weight parameters in the model, and obtaining:

$$w\_t ⟵ w\_ ( t - l ) - {g\_t}^{′}$$

The step S3 further includes:
in each real-time epoch iteration training process, continuously performing the iteration process of the weight parameters, continuously updating the weight parameters of the pre-training model, and obtaining the weight parameter model obtained by the current epoch iteration training process after repeated iteration learning, that is, updating of the weight parameters; and
after each epoch iteration training process, predicting a result of the verification set using the weight parameter model obtained by the current epoch iteration training process, where the predicting the result is same as the steps S31-S37, and calculating the loss value of the verification set.

The loss value of the verification set is calculated by:
establishing a loss function of the pre-training model, where a rectangular frame loss value lossrect, a confidence loss value lossobj, and a classification loss value lossclc are involved in training and verifying the model:

$$Loss = a * lossobj + b * lossrect + c * lossclc$$

where a, b, and c represent weights, and a=0.4, b=0.3, c =0.3;
using the loss function as the loss value of the training set and the loss value of the verification set;
where the rectangular frame loss value lossrect is calculated by using the pre-training model based on CLOU_loss as follows:

$$\begin{matrix}CIOU\_loss = 1 - CIOU \\ CIOU = IOU - \frac{Distance\_ {2}^{2}}{{Distance\_C}^{2}} - \frac{{V}^{2}}{( 1 - IOU ) + V}\end{matrix}$$

where IOU=A/B, A represents the number of pixels of an intersection of a labeled real frame and the prediction frame, B represents the number of pixels of a union of the labeled real frame and the real frame, Distance_C represents a diagonal distance of a minimum bounding rectangle of the labeled real frame and the prediction frame, Distance_2 represents an Euclidean distance between a central point of the labeled real frame and a central point of the prediction frame, and V represents a parameter for measuring consistency of an aspect ratio and is defined as:

$$V = \frac{4}{π} {( arc tan \frac{{w}^{gt}}{{h}^{gt}} - arc tan \frac{{w}^{p}}{{h}^{p}} )}^{2}$$

where wgt represents a width of the real frame, hgt represents a length of the real frame, wp represents a width of the prediction frame, and hp represents a length of the prediction frame.

The loss value of the verification set is further calculated by:
calculating the confidence loss value lossobj and the classification loss value lossclc by using the pre-training model based on BCE_loss:

$$BCE\_loss = - \frac{1}{f} {\sum }_{u} ( {y}_{f} * Ind + ( 1 - {y}_{f} ) * ( ln ( 1 - Ind ) ) )$$

where f represents the total number of samples, u represents the samples, y_{f} represents a label, and d represents a predicted output;
in the case of calculating the confidence loss value, f represents the number of data samples involved in training or verifying the model, u represents a sample among the samples, y_{f} represents a sample labeling confidence, and d represents a prediction confidence; where the sample labeling confidence is set to 1 in the present disclosure;
in the case of calculating the classification loss value, f represents the number of data samples involved in training or verifying the model, u represents a sample among the samples, y_{f} represents a sample labeling category, and d represents a prediction category; where there is only one labeling category in the present disclosure, that is, a category with an edge-to-point ratio of 1;
obtaining, based on the above calculation, a loss value of the weight parameter model based on the verification set after the real-time epoch training process;
where after each epoch iteration training process, a weight parameter model is obtained, and a loss value of the weight parameter model based on the verification set is obtained.

The determining a learning state of the pre-training model based on a change of the loss value of the verification set, and saving a current optimal model in real time; and obtaining an overall optimal model after m epoch training processes where m represents a positive integer includes:
outputting a loss value of the verification set after a single epoch as a single loss value of the verification set;
determining that the model is learning the image features in a case that the single loss value of the verification set decreases in the training process; where val_loss decreases from 4.95 to 3.2 near 250 epochs as shown in FIG. 4, and the val_loss represents the loss value of the verification set, that is, the Loss value calculated above;
determining that an output model reaches a maximum learning limit in a case that the single loss value of the verification set remains unchanged, that is, a difference between single loss values of the verification set corresponding to adjacent epochs is less than or equal to a difference threshold; where the val_loss fluctuates around 3.2 as shown in FIG. 4;
outputting the weight parameter model reaching the maximum learning limit as a real-time optimal model; and
outputting a weight parameter model with a minimum loss value of the verification set in the training process as the overall optimal model, where the loss value of the verification set is a set of values including single loss values of the verification set corresponding to the weight parameter model reaching the maximum learning limit in the m epoch training processes, and the overall optimal model is an optimal model in 350 epoch training processes.

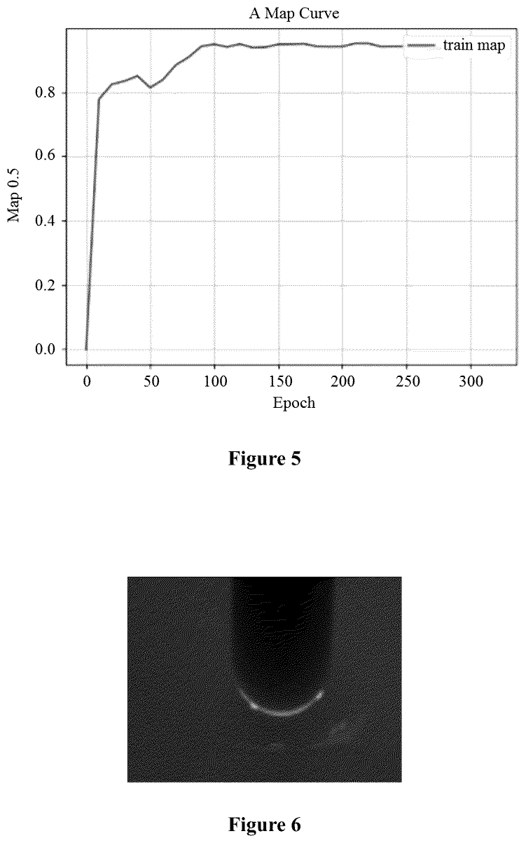

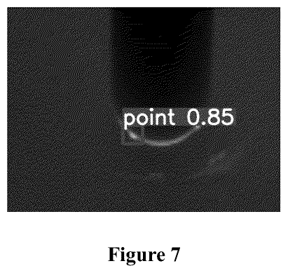

The step S4 includes:
testing the overall optimal model based on on the testing set, and calculating the IOU of the prediction frame and a labeled frame of the data set;
calculating an average detection precision mAP for all categories based on the following equation:

$$mAP = \frac{sum ( AP )}{n}$$

where AP represents an average precision of all images for each of the categories, n represents the number of the categories for detection, and n is set to 1 in the present disclosure;
where the AP equal to an area value of a region enclosed by a precision ratio Precision, a recall ratio Recall, an X axis, and a Y axis;

$$\begin{matrix}Precision = \frac{TP}{TP + FP} \\ Recall = \frac{TP}{GT}\end{matrix}$$

where TP represents the number of detection frames in a case of IOU greater than a predetermined IOU threshold, FP represents the number of the detection frames in a case of IOU less than or equal to the predetermined IOU threshold, and GT represents the number of the labeled frames of the data set; and the IOU threshold is set to 0.5 in the present disclosure;
calculating an AP value for each of the categories for detection, that is, mAP=AP, where the number of category is 1 in the present disclosure;
where in inputting the data of the testing set to the model for testing, a sample pool calculates a set of Precision-Recall values once a sample is inputted; in this way, the sample pool gradually expands from 0 to the whole testing set to obtain a number of sets of Precision-Recall values; the Precision-Recall values are marked in a rectangular coordinate system to obtain a curve (PR-curve), and the area of the region enclosed by the PR-curve, the X axis, and the Y axis is the AP value, that is, the mAP value in the present disclosure; and
configuring an accuracy threshold r corresponding to the actual production standard, where in a case that mAP is greater than or equal to r, the outputted overall optimal model meets the actual production standard; where r is set to 90% in the present disclosure, FIG. 5 shows changes of precision, FIGS. 6 and 7 show the difference between image data that is detected by a trained optimal model and image data that is not detected by the model, indicting the practical application effect of the present disclosure.

It should be noted that the embodiments in this specification are described in a progressive manner. Each of the embodiments focuses on differences with other embodiments, and the same or similar parts of the embodiments may be with reference to each other. Description of the device disclosed in the embodiments is simplified, since the device corresponds to the method disclosed in the embodiments, reference may be made to the description of the method for related explanations.

Finally, it should be further noted that a relation term such as “first” and “second” herein is only used to distinguish one entity or operation from another entity or operation, and does not necessarily require or imply that there is an actual relation or sequence between these entities or operations. Moreover, the terms “comprise”, “include”, or any other variants thereof are intended to encompass a non-exclusive inclusion, such that the process, method, article, or device including a series of elements includes not only those elements but also those elements that are not explicitly listed, or the elements that are inherent to such process, method, article, or device. Unless explicitly limited, the statement “including a . . . ” does not exclude the case that other similar elements may exist in the process, method, article or device other than enumerated elements.

Based on the above description of the disclosed embodiments, those skilled in the art can implement or carry out the present disclosure. Various modifications made to these embodiments are apparent to those skilled in the art. The general principle defined herein may be implemented in other embodiments without departing from the spirit or scope of the present disclosure. Therefore, the present disclosure shall not be limited to the embodiments described herein, but have the widest scope that complies with the principle and novelty disclosed in this specification.

The above descriptions show only some preferred embodiments of the present disclosure. It should be noted that those skilled in the art may make various modifications and variations to the present disclosure without departing from the spirit of the present disclosure, and these modifications and variations fall within the protection scope of the present disclosure.

1. A method for identifying and detecting an edge and a corner of a monocrystal line of a seed crystal in a crystal growth process, comprising:
step S1, collecting, by using an industrial camera in a CCD system, an angular image of the monocrystal line of the seed crystal that meets a seeding condition after a temperature regulation process and before a seeding process, performing single-frame labeling processing on feature points based on the collected angular image to construct a data set, and dividing the data set into a training set, a testing set, and a verification set based on a first proportion;
step S2, determining a pre-training model based on a labeled data set and a system application scenario, and constructing a training algorithm for a deep learning model based on the pre-training model, wherein the training algorithm comprises image data processing, loss value calculation, and weight parameter iteration of the pre-training model;
step S3, performing an iteration training process using the training algorithm for the deep learning model based on data in a labeled training set; performing real-time verification with the verification set in the iteration training process, and recording a loss value of the training set and a loss value of the verification set; determining a learning state of the pre-training model based on a change of the loss value of the verification set, and saving a current optimal model in real time; and obtaining an overall optimal model after m epoch training processes, wherein m represents a positive integer; and
step S4, testing the overall optimal model based on the testing set to obtain a model identification accuracy, and determining whether the model identification accuracy meets an actual production standard.

2. The method for identifying and detecting an edge and a corner of a monocrystal line of a seed crystal in a crystal growth process according to the claim 1, wherein the seeding condition indicates that the monocrystal line is in a full angular state, the feature points indicate an edge and a corner of the seed crystal meeting the seeding condition in the angular image, and the single-frame labeling processing is performed for labeling the feature points of the edge and the corner.

3. The method for identifying and detecting an edge and a corner of a monocrystal line of a seed crystal in a crystal growth process according to the claim 1, wherein the performing an iteration training process based on data in a labeled training set, performing real-time verification with the verification set in the iteration training process, and recording a loss value of the training set and a loss value of the verification set comprises:
step S31, inputting an image with a size of 640*640*3, slicing the inputted image using a Focus module to obtain a sliced image with a size of of 320*320*12, integrating a height and a width of the sliced image using Concat, and adding the number of channels of the inputted image to obtain a first processed image with a size of 320*320*64, wherein the number of the channels of the inputted image is 64;
step S32, performing feature extraction on the integrated image by using a convolution module Conv with a size of 3 and a step size of 2, and outputting a first feature image with a size of 160*160*128;
step S33, performing convolution on the first feature image using three sets of BottleneckCSP1 and Conv to obtaining a second feature image with a size of 20*20*1024; performing four maximum pooling operations, comprising a 1*1 maximum pooling operation, a 5*5 maximum pooling operation, a 9*9 maximum pooling operation and a 13*13 maximum pooling operation, on the second feature image by using a SSP module to extract image features, and aggregating, by using Concat, four feature images after the four maximum pooling operations to obtain a third feature image;
step S34, processing the third feature image by using a BottleneckCSP2 module to reduce the number of parameters of the pre-training model, and performing an up-sampling operation to obtain a fourth feature image with a size of 80*80*512;
step S35, performing a down-sampling operation on the fourth feature image to obtain a 80*80*512 feature image, a 40*40*512 feature image, and a 20*20*512 feature image;
step S36, performing a Conv2d convolution operation respectively on the 80*80*512 feature image, the 40*40*512 feature image and the 20*20*512 feature image to obtain a 80*80*255 feature image, a 40*40*255 feature image, and a 20*20*255 feature image;
step S37, outputting a prediction frame based on the 80*80*255 feature image, the 40*40*255 feature image, the 20*20*255 feature image, and the parameters of the pre-training model; comparing the prediction frame with a real frame labeled in the feature images to calculate a loss value of the prediction frame and a loss value of the real frame; and performing reverse updating and iteration to optimize weight parameters of the pre-training model; and
step S38, performing iteration on the parameters of the pre-training model based on the data of the training set, and outputting a weight parameter model obtained by the real-time epoch iteration training process.

4. The method for identifying and detecting an edge and a corner of a monocrystal line of a seed crystal in a crystal growth process according to the claim 3, wherein the iteration process for the weight parameters comprises:
assuming a hyper-parameter β1 meeting 0≤β1≤1, wherein β1 is set to 0.9, and obtaining a weighted average of a momentum variable vₜ and a random gradient gₜ at a time step t:
$$v t ← β 1 {v}_{t - 1} + ( 1 - β 1 ) {g}_{t}$$
at the time step t, obtaining:
$$vt = ( 1 - β 1 ) {\sum }_{i = 1}^{t} β {1}^{t - i} {g}_{i}$$
wherein gᵢ represents a random gradient at a time step i, and weights of random gradients of past time steps are added:
$$( 1 - β 1 ) {\sum }_{i = 1}^{t} {β1}^{t - i} {g}_{i} = 1 - β {1}^{t}$$
performing deviation correction, wherein in a case that t is small, a sum of batch random gradients of the past time steps is small, and for any time step t, dividing vₜ by 1−β1^{t} to obtain:
$${v}_{t}^{′} ← \frac{{v}_{t}}{1 - β {1}^{t}}$$
obtaining a weighted average of a variable nₜ and a square of the random gradient gₜ at the time step t:
$${n}_{t} ← β 1 {n}_{t - 1} + ( 1 - β1 ) {g}_{t}^{2}$$
reducing impact of small t by
$${n}_{t}^{′} ← \frac{{n}_{t}}{1 - {β1}^{t}} ;$$
obtaining corrected
$${v}_{t}^{′} \cdot {n}_{t}^{′}$$
at each time step t, and adjusting a learning rate of each of weight parameters in the parameters of the training model by performing an element-by-element operation:
$${g}_{t}^{′} ← \frac{η {v}_{t}^{′}}{\sqrt{{n}_{t}^{′}} + ϵ}$$
wherein η represents the learning rate, and ϵ represents a constant and ϵ=10⁻⁸; and
using the calculated gₜ′ to iterate the weight parameters in the model, and obtaining:
$$w\_t ← w\_ ( t - 1 ) - {g\_t}^{′}$$

5. The method for identifying and detecting an edge and a corner of a monocrystal line of a seed crystal in a crystal growth process according to the claim 4, wherein the step S3 further comprises:
in each real-time epoch iteration training process, continuously performing the iteration process of the weight parameters, continuously updating the weight parameters of the pre-training model, and obtaining the weight parameter model obtained by the current epoch iteration training process after repeated iteration learning, that is, updating of the weight parameters; and
after each epoch iteration training process, predicting a result of the verification set using the weight parameter model obtained by the current epoch iteration training process, wherein the predicting the result is same as the steps S31-S37, and calculating the loss value of the verification set.

6. The method for identifying and detecting an edge and a corner of a monocrystal line of a seed crystal in a crystal growth process according to the claim 5, wherein the calculating the loss value of the verification set comprises:
establishing a loss function of the pre-training model, wherein a rectangular frame loss value lossrect, a confidence loss value lossobj, and a classification loss value lossclc are involved in training and verifying the model:
$$Loss = a * lossobj + b * lossrect + c * lossclc$$
wherein a, b, and c represent weights, and a=0.4, b=0.3, c =0.3;
using the loss function as the loss value of the training set and the loss value of the verification set;
wherein the rectangular frame loss value lossrect is calculated by using the pre-training model based on CLOU_loss as follows:
$$CIOU\_loss = 1 - CIOU$$
$$CIOU = IOU - \frac{Distance\_ {2}^{2}}{{Distance\_C}^{2}} - \frac{{V}^{2}}{( 1 - IOU ) + V}$$
wherein IOU=A/B, A represents the number of pixels of an intersection of a labeled real frame and the prediction frame, B represents the number of pixels of a union of the labeled real frame and the real frame, Distance_C represents a diagonal distance of a minimum bounding rectangle of the labeled real frame and the prediction frame, Distance_2 represents an Euclidean distance between a central point of the labeled real frame and a central point of the prediction frame, and V represents a parameter for measuring consistency of an aspect ratio and is defined as:
$$V = \frac{4}{π} {( arctan \frac{{w}^{gt}}{{h}^{gt}} - arctan \frac{{w}^{p}}{{h}^{p}} )}^{2}$$
wherein wgt represents a width of the real frame, hgt represents a length of the real frame, wp represents a width of the prediction frame, and hp represents a length of the prediction frame.

7. The method for identifying and detecting an edge and a corner of a monocrystal line of a seed crystal in a crystal growth process according to the claim 6, wherein the loss value of the verification set is further calculated by:
calculating the confidence loss value lossobj and the classification loss value lossclc by using the pre-training model based on BCE_loss:
$$BCE\_loss = - \frac{1}{f} {\sum }_{u} ( {y}_{f} * ln d + ( 1 - {y}_{f} ) * ( ln ( 1 - ln d ) ) )$$
wherein f represents the total number of samples, u represents the samples, y_{f} represents a label, and d represents a predicted output;
in the case of calculating the confidence loss value, f represents the number of data samples involved in training or verifying the model, u represents a sample among the samples, y_{f} represents a sample labeling confidence, and d represents a prediction confidence;
in the case of calculating the classification loss value, f represents the number of data samples involved in training or verifying the model, u represents a sample among the samples, y_{f} represents a sample labeling category, and d represents a prediction category;
obtaining, based on the above calculation, a loss value of the weight parameter model based on the verification set after the real-time epoch training process;
wherein after each epoch iteration training process, a weight parameter model is obtained, and a loss value of the weight parameter model based on the verification set is obtained.

8. The method for identifying and detecting an edge and a corner of a monocrystal line of a seed crystal in a crystal growth process according to the claim 7, wherein the determining a learning state of the pre-training model based on a change of the loss value of the verification set, and saving a current optimal model in real time; and obtaining an overall optimal model after m epoch training processes wherein m represents a positive integer comprises:
outputting a loss value of the verification set after a single epoch as a single loss value of the verification set;
determining that the model is learning the image features in a case that the single loss value of the verification set decreases in the training process;
determining that an output model reaches a maximum learning limit in a case that the single loss value of the verification set remains unchanged, that is, a difference between single loss values of the verification set corresponding to adjacent epochs is less than or equal to a difference threshold;
outputting the weight parameter model reaching the maximum learning limit as a real-time optimal model; and
outputting a weight parameter model with a minimum loss value of the verification set in the training process as the overall optimal model, wherein the loss value of the verification set is a set of values comprising single loss values of the verification set corresponding to the weight parameter model reaching the maximum learning limit in the m epoch training processes, and the overall optimal model is an optimal model in 350 epoch training processes.

9. The method for identifying and detecting an edge and a corner of a monocrystal line of a seed crystal in a crystal growth process according to the claim 8, wherein the step S4 comprises:
testing the overall optimal model based on on the testing set, and calculating the IOU of the prediction frame and a labeled frame of the data set;
calculating an average detection precision mAP for all categories based on the following equation:
$$mAP = \frac{sum ( AP )}{n}$$
wherein AP represents an average precision of all images for each of the categories, and n represents the number of the categories for detection;
wherein the AP equal to an area value of a region enclosed by a precision ratio Precision, a recall ratio Recall, an X axis, and a Y axis;
$$Precision = \frac{TP}{TP + FP}$$
$$Recall = \frac{TP}{GT}$$
wherein TP represents the number of detection frames in a case of IOU greater than a predetermined IOU threshold, FP represents the number of the detection frames in a case of IOU less than or equal to the predetermined IOU threshold, and GT represents the number of the labeled frames of the data set;
calculating an AP value for each of the categories for detection, that is, mAP-AP; and
configuring an accuracy threshold r corresponding to the actual production standard, wherein in a case that mAP is greater than or equal to r, the outputted overall optimal model meets the actual production standard.
